(19) United States
(12) Patent Application Publication
(10) Pub. No.: US 2024/0191401 A1
(43) Pub. Date: Jun. 13, 2024

(54) SYSTEM FOR TENSIONING A DRIVE BELT OF A DRAFTING SYSTEM WITH A DRAFTING SYSTEM AND A BELT TENSIONER

(71) Applicant: Saurer Spinning Solutions GmbH & Co. KG, Ubach-Palenberg (DE)

(72) Inventors: Michael Reimann, Grevenbroich (DE); Heiko Toepke, Baesweiler (DE)

(73) Assignee: Saurer Spinning Solutions GmbH & Co. KG, Übach-Palenberg (DE)

(21) Appl. No.: 18/517,204

(22) Filed: Nov. 22, 2023

(30) Foreign Application Priority Data
Dec. 7, 2022 (LU) 503149

(51) Int. Cl. D01H 1/241; F16H 7/08

(52) U.S. Cl. CPC D01H 1/241; F16H 7/08; F16H 2007/0842

(57) ABSTRACT

The invention relates to a tensioner for a spinning machine, having at least two pairs of rollers, which each have a top roller and a bottom roller, and at least one drive motor for driving at least one of the bottom rollers, wherein the at least one drive motor and the bottom roller, which can be driven by the at least one drive motor, are arranged on a bottom roller carrier, wherein the at least one drive motor, which is connected to the bottom roller via a drive belt, is arranged on the bottom roller carrier such that its distance from the bottom roller can be varied in order to set a drive belt tension. The invention further relates to belt tensioner jaws for adjusting the drive belt tension of a tensioner, and to a system for tensioning a drive belt of a tensioner, comprising a tensioner and a belt tensioner jaw.

In order to provide a tensioner, a belt tensioner jaw and a system comprising a tensioner and a belt tensioner, which enable simple adjustment of the drive belt tension, it is provided for the tensioner that the at least one drive motor is mounted on the bottom roller carrier so as to be pivotable about an axis of rotation and fixable in a set position.

The invention relates to a tensioner for a spinning machine, having at least two pairs of rollers, which each have a top roller and a bottom roller, and at least one drive motor for driving at least one of the bottom rollers, wherein the at least one drive motor and the bottom roller, which can be driven by the at least one drive motor, are arranged on a bottom roller carrier, wherein the at least one drive motor, which is connected to the bottom roller via a drive belt, is arranged on the bottom roller carrier such that its distance from the bottom roller can be varied in order to set a drive belt tension. The invention further relates to belt tensioner jaws for adjusting the drive belt tension of a tensioner, and to a system for tensioning a drive belt of a tensioner, comprising a tensioner and a belt tensioner jaw.

A wide variety of prior art tensioners for spinning machines are known. They are used to draw or draft a fiber band, thereby causing a reduction in cross-section of the fiber. During drafting, the fibers must be transported as evenly as possible next to one another in order to achieve a uniform fiber sliver, which is a prerequisite for the production of a uniform yarn.

For stretching the fiber sliver, the tensioners usually have a plurality of pairs of rolls arranged one after the other, which, lying against one another, clamp the fiber sliver extending between them. A pair of rollers usually consists of a driven bottom roller and an upper pressure roller that rests against the bottom roller. Drafting of the fiber sliver is achieved by increasing the circumferential speed from roller pair to roller pair in the transport direction of the fiber sliver determined by the direction of rotation of the roller pairs.

To drive the bottom rollers, which are rotatably mounted on a bottom roller carrier of the tensioner, it is known to use drive motors assigned to the individual bottom rollers for this purpose, which drive the bottom rollers via a drive belt. To ensure reliable power transmission from the drive motor to the bottom roller, it is necessary for the drive belt connecting the drive motor and the bottom roller to have a specified drive belt tension.

To adjust the drive belt tension, the drive motor of known tensioners is mounted longitudinally displaceable on a motor plate. A longitudinal displacement causes a change in the distance between the drive motor and the bottom roller, which can be used to adjust the drive belt tension. For this purpose, the drive motor is displaced on the motor plate to a position specified for the required drive belt tension and fixed there by means of suitable fastening means.

When fixing the drive motor, misalignments can occur, which is why it is necessary to check the drive belt tension after each tensioning process, wherein elaborate frequency measurements usually have to be performed for this purpose. These are very costly and time-consuming, particularly in the case of tensioners where the individual bottom rollers are connected to the drive motors via different belt lengths.

Based on this, the object of the invention is to provide a tensioner, a belt tensioner jaw and a system of tensioner and belt tensioner jaw which allow simple adjustment of the drive belt tension.

The invention achieves the object by a tensioner having the features of claim 1, a belt tensioner jaw for adjusting the drive belt tension of a tensioner having the features of claim 8, and by a system for tensioning a drive belt of a tensioner, comprising a tensioner and a belt tensioner jaw having the features of claim 12. Preferred further embodiments of the invention are given in the dependent claims.

A characteristic feature of the tensioner according to the invention is that the at least one drive motor of the at least one bottom roller rotatably mounted on the bottom roller carrier is mounted on the bottom roller carrier in such a manner that it can be pivoted about an axis of rotation and fixed in a set position in order to set its distance from the associated bottom roller. According to the invention, the drive motor is also connected to the bottom roller carrier in a stationary manner during the adjustment of its position via the axis of rotation. The axis of rotation extends on the bottom roller carrier in such a manner that a change in the distance of the drive motor from the bottom roller, or of a drive shaft axis of the drive motor from an axis of rotation of the bottom roller, is effected by pivoting the drive motor about the axis of rotation. The stationary arrangement of the drive motor via the axis of rotation thus enables the drive motor, which can be pivoted relative to the bottom roller carrier, to be conveniently pivoted into the position in which the distance between the drive motor and the bottom roller required for the necessary drive belt tension is present. Permanent maintenance of the connection between the drive motor and the bottom roller carrier via the axis of rotation reliably prevents tilting of the drive motor, as a result of which the drive belt tension in the set position deviates from the drive belt tension intended for this purpose. To set the drive belt tension, markings can be provided on the bottom roller carrier, for example, which are assigned to corresponding drive belt tensions when the drive motor is positioned accordingly. The tensioner according to the invention thus enables particularly simple and reliable adjustment of the drive belt tension and thus ensures reliable operation of the tensioner. This also makes it possible to compensate in particular for circumferential tolerances, e.g. between different production batches of the drive belts.

In principle, it is possible to arrange both the axis of rotation, via which the drive motor is mounted on the bottom roller carrier, and the bottom roller as well as the drive motor in such a manner that their drive shaft axis and axis of rotation have different orientations. According to a preferred embodiment of the invention, however, it is provided that the at least one drive motor is pivotably mounted on the bottom roller carrier in such a manner that the axis of rotation, the drive shaft axis of the at least one drive motor and the axis of rotation of the associated bottom roller are arranged parallel to one another. This embodiment of the invention ensures both easy adjustability of the drive belt tension and reliable power transmission from the drive motor to the bottom roller. In addition, a corresponding design ensures that the drive belt tension increases or decreases as a function of the pivoting movement in proportion to the pivoting of the drive motor about the axis of rotation.

The extent to which the drive motor can be adjusted on the bottom roller carrier, namely the pivoting of the drive motor about the axis of rotation, can basically be designed in any manner. According to a preferred embodiment of the invention, however, it is provided that the at least one drive motor is adjustably arranged on the bottom roller carrier between an end position defining a maximum distance to the bottom roller and an initial position defining a minimum distance to the bottom roller. A corresponding embodiment of the invention ensures that the drive belt can be conveniently arranged on the drive motor and the associated bottom roller when the drive motor is located in the area of the initial position. In addition, the end position ensures that the drive belt tension does not exceed a maximum tension. In addition, the limited adjustment range of the drive motor reliably prevents incorrect positioning that could result in damage to the drive motor or neighboring aggregates of the tensioner.

The alignment of the drive motor, in particular the axis of rotation relative to the bottom roller on the bottom roller carrier, can in principle be carried out in any way, provided that it is ensured that a change in distance between the drive motor and the bottom roller occurs when the drive motors are pivoted about their axis of rotation. According to a preferred embodiment of the invention, it is provided that the drive motor is pivotably arranged on the bottom roller carrier in such a manner that, in a center position having a corresponding distance from the start and end positions, a plane spanned by the axis of rotation and the associated drive shaft axis extends perpendicularly to a plane spanned by the associated drive shaft axis and the axis of rotation of the associated bottom roller.

This embodiment of the invention ensures that adjustment movements of the drive motor, starting from the center position and moving toward the end or start position, increase or decrease the drive belt tension in unison. In both directions of adjustment, the adjustment travel is consistently proportional to the increase or decrease in drive belt tension. In addition, a corresponding design ensures a very compact design of the tensioner as well as good accessibility to the drive motors, so that the drive belt tension can be adjusted in a convenient manner.

The drive motor can basically be adjusted in any manner to set the drive belt tension. According to a preferred embodiment of the invention, it is provided that the drive motor has an extension bolt extending parallel to an associated holding bolt on the bottom roller carrier, wherein the holding bolt and the associated extension bolt are arranged at a distance from each other such that their change in distance causes the drive motor to be adjusted between the initial position and the end position.

In accordance with this preferred embodiment of the invention, a holding bolt is assigned to the at least one drive motor or, in the case of more than one drive motor, in a preferred manner to each drive motor on the bottom roller carrier, which holding bolt is arranged in a fixed position on the bottom roller carrier. Furthermore, the at least one drive motor or, in the case of more than one drive motor, preferably each drive motor has a slip-on bolt which extends parallel to the respective holding bolts. The drive motor can thus be positioned by changing the distance between the slip-on bolt and the holding bolt. This embodiment of the invention thus makes it possible to use, for example, gauges which are provided with openings for the slip-on bolt and the holding bolt. The distance between the openings is assigned to defined drive belt tensions, such that the teachings can be used for both setting and checking the drive belt tension. To adjust the drive belt tension, it is only necessary to arrange the slip-on bolt opposite the holding bolt in such a manner that they coincide with the openings arranged in the teaching.

In addition, the holding bolt and slip-on bolt further enable the use of a tool adapted to them for adjusting the distance between the holding bolt and slip-on bolt and thus for reliably setting the drive belt tension. In accordance with a preferred design, the slip-on bolt extends through a recess on the bottom roller carrier, wherein the recess is designed, for example, as an elongated hole, through which both a reliable guide of the slip-on bolt is conveniently ensured and the end and start positions can be precisely defined.

According to a preferred embodiment, the bottom roller carrier has an upper side and a lower side, wherein the bottom rollers are mounted on the upper side of the bottom roller carrier, and a carrying element is provided which projects vertically from the lower side to the latter and on which the at least one drive motor is mounted. The drive belt extends from the drive motor to the associated bottom roller, crossing the bottom and upper sides of the bottom roller carrier. According to a preferred embodiment, the bottom roller carrier and the carrying element can be formed in one piece or in several pieces. In the case of a multi-part design, the bottom roller carrier and the supporting element are further preferably connected or coupled to one another by means of conventional connection and/or coupling elements.

In accordance with a preferred embodiment, the bottom roller carrier has a passage through which the drive belt extends. Preferably, the passage can be designed as an opening in the bottom roller carrier partially or completely enclosed by an edge. In the case of the partially rimmed design, the opening rim surrounding the opening and thus limiting it preferably simultaneously forms a rim side of the bottom roller carrier. This allows easy access to the passage from the edge side of the bottom roller carrier. In an equivalently preferred manner, the recess through which the slip-on bolt preferably projects can be formed in the bottom roller carrier or its carrying element.

The fixing of the at least one drive motor in the set position can basically be done in any manner. According to a preferred embodiment of the invention, the bottom roller carrier has for this purpose at least one receptacle for receiving at least one locking screw which extends through the bottom roller carrier and fixes the at least one drive motor in the set position. In accordance with this embodiment, at least one screw is screwed to the bottom roller carrier through a recess in order to fix the drive motor in the set position, so that the drive motor can be clamped to the bottom roller carrier in the set position via the screw. The recess is dimensioned in such a manner that the drive motor can be fixed in all the positions of the drive motor provided between the initial and end positions.

The use of slip-on bolts and holding bolts provided in accordance with an advantageous further development of the invention also makes it possible to use a belt tensioner jaw according to the invention for adjusting the drive belt tension of the tensioner. The belt tensioner jaw has two jaw halves which are pivotably connected to one another via a hinge bolt, one end of which is designed as a handle and the other ends of which each have a functional element which together form a pair of functional elements. The functional elements are arranged in the same movement plane and can be moved towards one another by actuating the jaw halves. A characteristic feature of the belt tensioner jaw according to the invention is a pretensioning element which pretensions the functional elements, which are designed as slip-on bushings for receiving a holding bolt and a slip-on bolt and extend perpendicularly to the plane of movement, towards each other with a defined pretensioning force.

The design of the belt tensioner jaw according to the invention with slip-on jaws, which are designed for the receptacle of holding bolts and slip-on bolts, by means of which a drive motor of the drafting system can be adjusted relative to an associated bottom roller for drive belt tensioning, enables convenient adjustment of the drive belt tension by means of the belt tensioner.

According to the invention, the pretensioning element, which pretensions the slip-on bolts towards one another, determines the distance between the holding bolt and the slip-on bolt and thus the positioning of the drive motor on the bottom roller carrier. By appropriate selection of the pretensioning element, following an arrangement of the belt tensioner jaw with the slip-on bushings on the associated holding bolts and slip-on bolts, the drive belt tension is adjusted in a reliable automated manner in accordance with the preload applied by the pretensioning element and acting on the drive belt. According to an arrangement of the belt tensioner jaw, the drive motor can be fixed in the position specified by the belt tensioner jaw without any further manual adjustment of the jaw halves, thus achieving an exact positioning of the drive motor with the specified drive belt tension.

The tensioning force exerted by the belt tensioner jaw on the holding bolt and slip-on bolt and thus on the drive belt, and thus the positioning of the drive motor on the bottom roller carrier, is determined as a function of the pretensioning force generated by the pretensioning element and the distance of the slip-on bushings from the hinge bolt of the belt tensioner jaw. An advantageously provided interchangeability of the pretensioning element thus enables the drive belt tension generated by the belt tensioner jaw to be adjusted. According to a preferred embodiment of the invention, it is further provided that the functional elements of a pair of functional elements are arranged at the same distance from the hinge bolt. This embodiment of the invention prevents incorrect operation of the belt tensioner jaw in a special manner, since in accordance with this embodiment of the invention it is irrelevant on which slip-on bushing the holding bolt and the slip-on bolt are arranged.

According to a further embodiment of the invention, it is further provided that pairs of functional elements are arranged at the other ends of the jaw halves at least at two different distances from the hinge bolt. Due to the different distance of the slip-on bushings of the at least two pairs of functional elements from the hinge bolt, different preloads can be transmitted to the holding bolts and associated slip-on bolts with a belt tensioner jaw without replacing the pretensioning element according to the number of pairs of functional elements. A corresponding design of the belt tensioner jaw thus also enables its sole use for setting the drive belt tension on tensioners in which several drive motors are operated with different drive belt tensions.

The design of the pretensioning element is basically freely selectable, as long as it provides a preload at which the slip-on bushings are pretensioned towards one another. Such a preload can be generated, for example, by a pressure spring arranged in the area of the handles. According to a preferred embodiment of the invention, however, the pretensioning element is designed as a tension spring arranged in the area between a pair of functional elements and the hinge bolt on the jaw halves. The use of a tension spring ensures a defined preload of the slip-on bushings of a pair of functional elements in a particularly simple and reliable manner. In addition, the tension spring can be replaced particularly easily, if necessary, so that the belt tensioner jaw can be used to apply different tensioning forces.

The object of the invention is further achieved by a system for tensioning a drive belt of a drafting system, having
a tensioner according to the invention or further described above, and
a belt tensioner jaw as described above according to the invention or as further described, wherein
mounted on the belt tensioner jaw forming a slip-on bolt and holding bolt are adapted.

The system according to the invention, consisting of a tensioner and belt tensioner jaw, allows the drive belt tension of the drive belts connecting the bottom roller to the drive motor to be adjusted in a particularly simple and convenient manner. Particularly advantageously, a pretensioning element is designed on the belt tensioner jaw in such a manner that the belt tensioner jaw arranged on the holding bolt and the slip-on bolt pretensions the drive belt with a predetermined belt tension. A corresponding system of tensioner and belt tensioner jaw thus enables the machine operator to provide the drive belt with a drive belt tension required for operation in a particularly simple and convenient manner. The apparatus of a tensioner as well as maintenance and servicing can thus be carried out in a particularly simple manner after the belt tensioner jaw ensures reliable belt tension. This also eliminates the need for additional tools to subsequently check the belt tension.

According to a preferred embodiment of the invention, the tensioner has at least two pairs of rollers, each with a drive motor connected to a bottom roller, and the belt tensioner jaw has two pairs of functional elements for setting different belt tensions. In accordance with this embodiment of the invention, the belt tensioner jaw can be used to apply different pretensioning forces to the slip-on bolt and the holding bolt via the two pairs of functional elements, which each have slip-on bushings arranged at different distances from the hinge bolt. This makes it possible to adjust a tensioner with drive belts with different required drive belt tensions by means of a belt tensioner jaw. In accordance with this embodiment of the invention, the use of a separate belt tensioner jaw for adjusting the second drive belt tension can be dispensed with.

An exemplary embodiment of the invention is explained below with reference to the drawings. In the drawings:

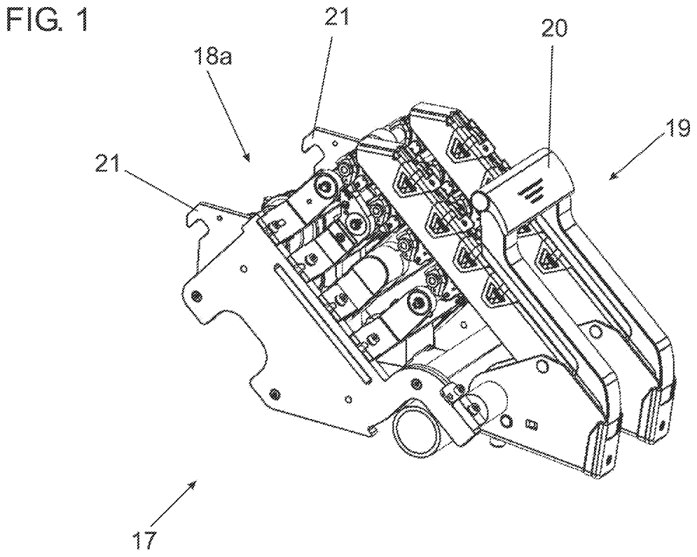

FIG. 1 shows a perspective view in schematic diagram of a first embodiment of a tensioner,

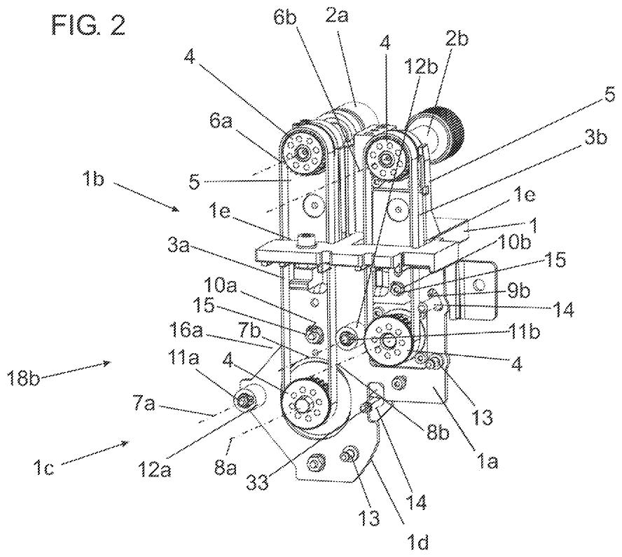

FIG. 2 shows a perspective view in schematic diagram of a tensioner base of a second embodiment of a tensioner,

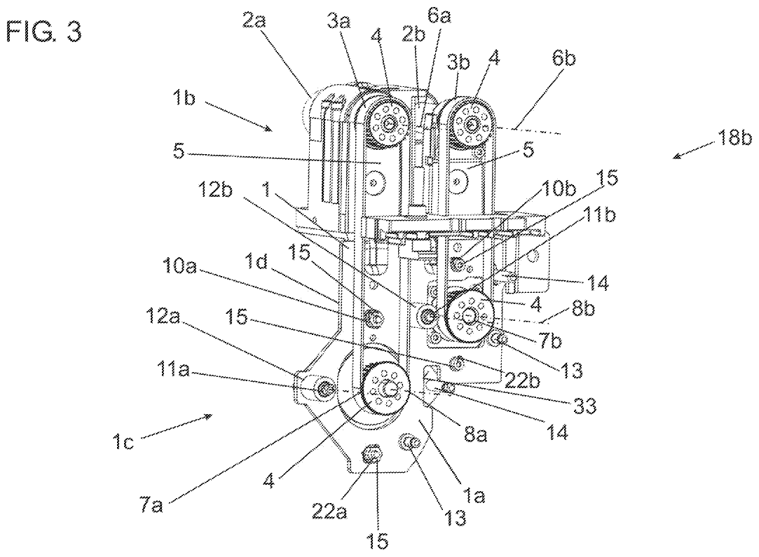

FIG. 3 shows another perspective view in schematic diagram of the tensioner bottom part of FIG. 2,

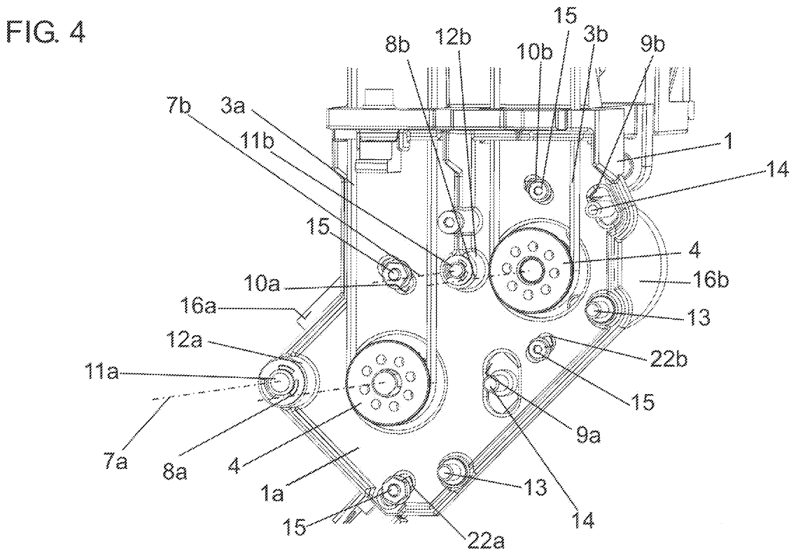

FIG. 4 shows a perspective view in schematic diagram of a section of the tensioner bottom part of FIG. 2,

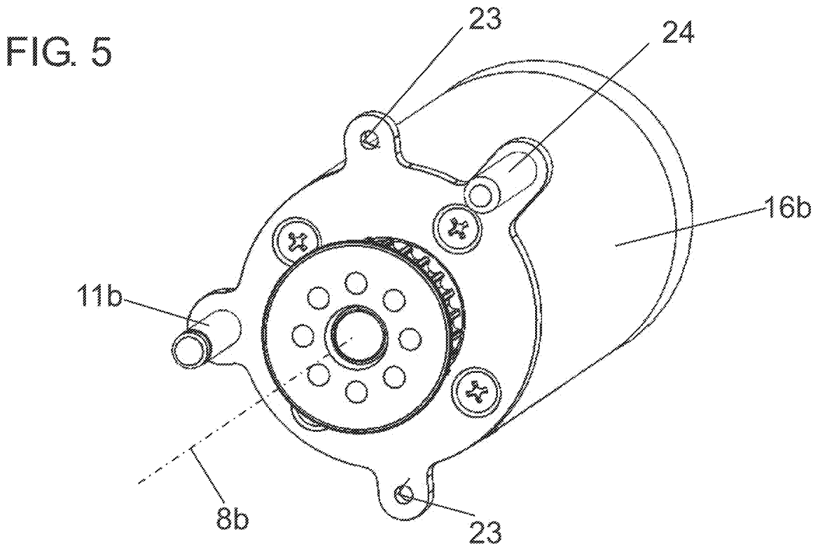

FIG. 5 shows a perspective view in schematic diagram of a first drive motor of the tensioner bottom part of FIG. 2,

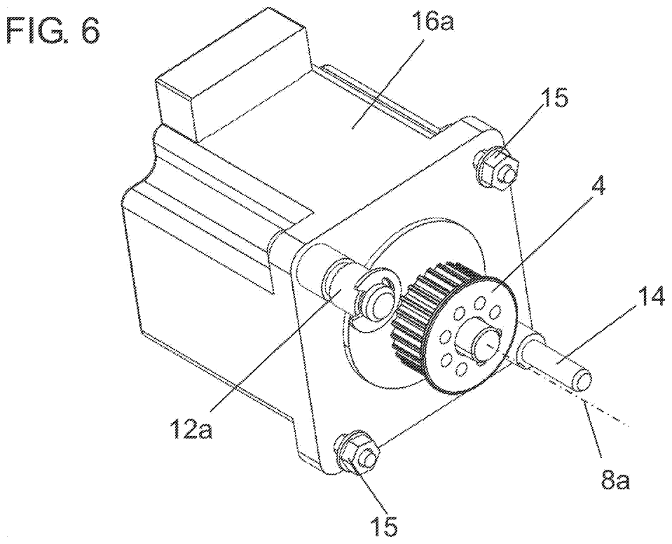

FIG. 6 shows a perspective view in schematic diagram of a second drive motor of the tensioner bottom part of FIG. 2,

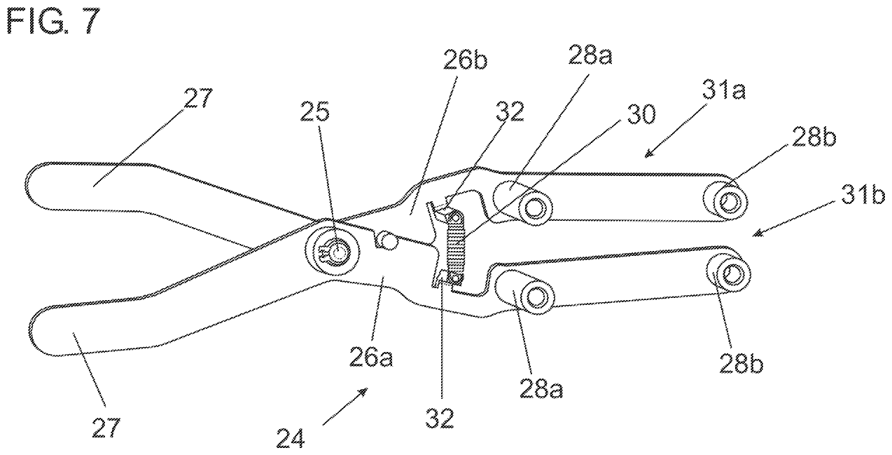

FIG. 7 shows a perspective view in schematic diagram of a belt tensioner jaw according to an exemplary embodiment,

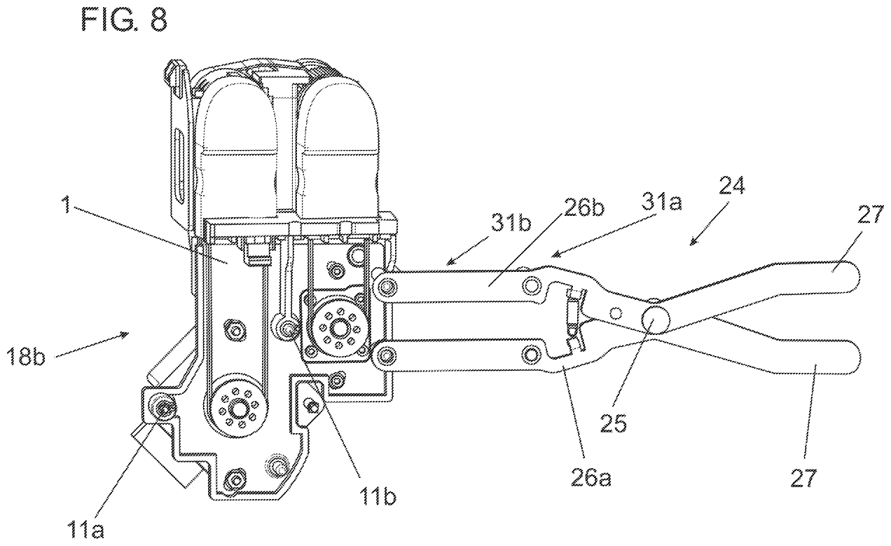

FIG. 8 shows a perspective view in schematic diagram of the tensioner bottom part of FIG. 2 in a first interaction with the belt tensioner jaw of FIG. 7 and

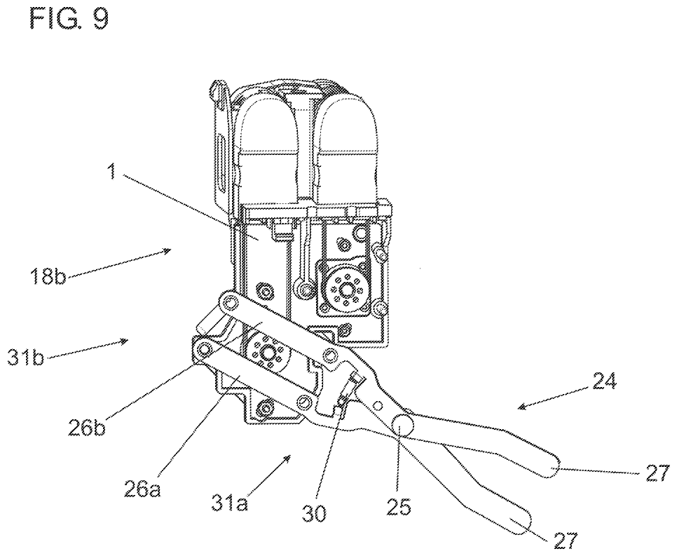

FIG. 9 shows a perspective view in schematic diagram of the tensioner bottom part of FIG. 2 in a second interaction with the belt tensioner jaw of FIG. 7.

FIG. 1 shows a schematic representation of a tensioner 17 which can be assigned to a spinning position of a textile machine not shown here and which can be fixed to the textile machine by means of latching hooks 21. The tensioner 17 has a tensioner top part 19 which is hingedly connected to a tensioner bottom part 18a, wherein pivoting is effected by actuating a handle 20.

In the operating position shown in FIG. 1, the tensioner top part 19 with four top rollers arranged one behind the other in the direction of travel of a fiber sliver not shown here through the tensioner 17 rests against the corresponding driven bottom rollers 2a, 2b of the tensioner bottom part 18a.

A second embodiment of a tensioner bottom part 18b is shown in a perspective view in FIGS. 2 and 3. The tensioner bottom part 18b has two bottom rollers 2a, 2b, which are rotatably mounted on the bottom roller carrier 1 on its upper side via bottom roller bearings 5 of a bottom roller carrier 1. To drive the bottom rollers 2a, 2b, the tensioner bottom part 18b has two drive motors 16a, 16b, each assigned to a bottom roller 2a, 2b. The drive motors 16a, 16b are each pivotably mounted on the carrying element 1b via a hinge bolt 11a, 11b, which extend through bearing bushes 12a, 12b on a carrying element 1b of the bottom roller carrier 1. The carrying element 1b is plate-shaped and extends vertically from a bottom side 1c of the bottom roller carrier 1 to it. According to this exemplary embodiment, the bottom roller carrier 1 is integrally designed with the carrying element 1b, in other words, it is designed in one part with the carrying element 1b. According to a preferred exemplary embodiment not shown, the bottom roller carrier 1 and the carrying element 1b can have a multi-part design and be connected or coupled to one another via conventional coupling or connecting elements. Two drive belts 3a, 3b each wrapping around a belt wheel 4 of a drive motor 16a, 16b and a bottom roller 2a, 2b serve to transmit the drive motion of the drive motors 16a, 16b to the bottom rollers 2a, 2b. These each extend across the bottom side 1c and the upper side 1b of the bottom roller carrier 1 through a respective passage of the bottom roller carrier 1.

In order to adjust the drive belt tension of the drive belts 3a, 3b, the drive motors 16a, 16b can be pivoted via the hinge bolts 11a, 11b predetermined axis of rotation 7a, 7b, whereby the distance of the belt wheels 4 of the bottom rollers 2a, 2b to the associated belt wheels 4 of the drive motors 16a, 16b can be adjusted.

To adjust the position of the drive motors 16a, 16b relative to the bottom rollers 2a, 2b on the bottom roller carrier 1, holding bolts 13 arranged stationary on the carrying element 1b and slip-on bolts 14 assigned to the respective holding bolts 13 are provided on the drive motors 16a, 16b. The slip-on bolts 14 project through an elongated hole 9b or recess 33 in the exemplary embodiment shown in FIGS. 2 and 3 and through elongated holes 9a, 9b on the carrying element 1b in the exemplary embodiment shown in FIG. 4, so that the holding bolts 13 and slip-on bolts 14 are arranged in one plane and aligned parallel to one another. The recess 33 differs from the elongated hole 9b or from the elongated holes 9a, 9b in that the recess 33 extends to an edge side of the carrying element 1b and thus forms an edge side of the carrying element 1b or of the bottom roller carrier 1 in order to allow accessibility via the edge side. The adjustment movement of the drive motors 16a, 16b is limited by the length of the elongated holes 9a, 9b or the recess 33. In this case, the distance between the holding bolt 13 and the slip-on bolt 14 defines the position of the drive motors 16a, 16b on the carrying element 1b of the bottom roller carrier 1, wherein the set position of the drive motors 16a, 16b is secured in each case by means of locking screws 15, which project through further elongated holes 10a, 10b, 22a, 22b and are screwed into openings 23 in the respective drive motors 16a, 16b, whereby the drive motors 16a, 16b can be fixed in their set position in a clamped manner on the carrying element 1b (cf. FIGS. 5 and 6).

In the center position shown in FIGS. 2 to 4, in which the slip-on bolts 14-with reference to FIG. 4-are arranged at the same distance from both ends of the elongated holes 9a, 9b, the axis of rotation 7a, 7b clamp with the respective drive shaft axis 8a, 8b of the associated drive motors 16a, 16b, which extends perpendicularly to a plane defined by the drive shaft axis 8a, 8b and the axis of rotation 6a, 6b of the associated bottom rollers 2a, 2b, wherein the drive shaft axis 8a, 8b, the axis of rotation 6a, 6b and the axis of rotation 7a, 7b extend parallel to one another.

The belt tensioner jaw 24 shown in a perspective representation in FIG. 7 is used to adjust the belt tension of the drive belts 3a, 3b. This has two jaw halves 26a, 26b, which are hinged together by a hinge bolt 25. On one side of the hinge bolt 25, the jaw halves 26a, 26b each form a handle 27, whereas on the sides opposite the handles 27, the jaw halves 26a, 26b each have two functional elements arranged at a distance from one another and designed as slip-on bushings 28a, 28b. The functional elements 28a, 28b each form a pair of functional elements 31a, 31b, which are pretensioned towards each other with a defined preload by a pretensioning element designed as a tension spring 30. Due to the different distance of the functional elements 28a, 28b of the pairs of functional elements 31a, 31b from the hinge bolt 25, the pairs of functional elements 31a, 31b transmit different pretensioning forces via the slip-on bushings 28a, 28b.

The slip-on bolts 28a, 28b are adapted to the slip-on bolts 14 and holding bolts 13 of the tensioner bottom part 18b so that the belt tensioner jaw 24, as represented in FIGS. 8 and 9, can be used to adjust the belt tension of the drive belts 3a, 3b. In the exemplary embodiment shown in FIG. 8, the pair of functional elements 31b is used to adjust the belt tension of the drive belt 3b connecting the second bottom roller 2b to the drive motor 16b. Due to a belt length of the first drive belt 3a deviating from the belt length of the second drive belt 3b, a deviating preload must be applied by the belt tensioner jaw 24 to the slip-on bolts 14 and holding bolts 13 to adjust the drive motor 16a in order to achieve the necessary drive belt tension. For this purpose, the belt tensioner jaw 24 is arranged with the slip-on bushings 28a of the pair of functional elements 31a on the holding bolt 13 and slip-on bolt 14 associated with the drive motor 16a.

The preload is determined by the tension spring 30 arranged in the area between the hinge bolt 25 and the pairs of functional elements 31a, 31b on holders 32 of the jaw halves 26a, 26b. The tension spring 30 is fastened interchangeably to the holders 32, so that the belt tensioner jaw 24 can be used to set different preloads by replacing the tension spring 30.

### LIST OF REFERENCE SIGNS

1 bottom roller carrier
1a carrying element
1b upper side
1c bottom
1d edge side
1e passage
2a first lower roller
2b second lower roller
3a first drive belt
3b second drive belt
4 belt wheel
5 bottom roller bearing
6a, 6b axis of rotation (bottom rollers)
7a, 7b axis of rotation
8a, 8b drive shaft axis
9a, 9b elongated hole
10a, 10b further elongated hole
11a, 11b hinge bolt
12a, 12b bearing bushing
13 holding bolt
14 slip-on bolt
15 locking screw
16a, 16b drive motor
17 tensioner
18a, 18b tensioner bottom part
19 tensioner top part
20 handle
21 latching hook
22a, 22b further elongated hole
23 openings
24 belt tensioner jaw
25 hinge bolt
26a first jaw halves
26b second jaw halves
27 handle
28a, 28b Functional element (slip-on bushing)
30 pretensioning element (tension spring)
31a, 31b functional element pair
32 holder
33 recess

1. A tensioner (17) for a spinning machine, having at least two pairs of rollers,
each having a top roller and a bottom roller (2a, 2b), and at least one drive motor (16a; 16b) for driving at least one of the bottom rollers (2a; 2b), wherein the at least one drive motor (16; 16b) and the bottom roller (2a; 2b) drivable by the at least one drive motor (16; 16b) are arranged on bearings on a bottom roller carrier (1), wherein the at least one drive motor (16a; 16b), which is connected to the bottom roller (2a; 3b) via a drive belt (3a; 3b), is arranged on the bottom roller carrier (1) so as to be variable in distance from the bottom roller (2a; 2b) for setting a drive belt tension,
characterized in that
the at least one drive motor (16a; 16b) is mounted on the bottom roller carrier (1) so as to be pivotable about an axis of rotation (7a; 7b) and fixable in a set position.

2. The tensioner (17) according to claim 1, characterized in that the at least one drive motor (16a; 16b) is pivotably mounted on the bottom roller carrier (1) in such a manner that the axis of rotation (7a; 7b), a drive shaft axis (8a; 8b) of the at least one drive motor (16a; 16b) and an axis of rotation (6a; 6b) of the associated bottom roller (2a; 2b) are arranged parallel to each one another.

3. The tensioner (17) according to claim 1, characterized in that the at least one drive motor (16a; 16b) is adjustably arranged on the bottom roller carrier (1) between an end position defining a maximum distance to the bottom roller (2a; 2b) and an initial position defining a minimum distance to the bottom roller (2a; 2b).

4. The tensioner (17) according to claim 1, characterized in that the at least one drive motor (16a; 16b) is pivotably arranged on the bottom roller carrier (1) in such a manner that, in a center position having a corresponding distance from the initial and final positions, a plane defined by the axis of rotation (7a; 7b) and the associated drive shaft axis (8a; 8b) extends perpendicularly to a plane defined by the associated drive shaft axis (8a; 8b) and the axis of rotation (6a; 6b) of the associated bottom roller (2a; 2b).

5. The tensioner (17) according to claim 1,
characterized in that the at least one drive motor (16a; 16b) has a slip-on bolt (14) extending parallel to an associated holding bolt (13) on the bottom roller carrier (1), wherein the holding bolt (13) and the associated slip-on bolt (14) are arranged in such a distance from one another that their change in distance causes an adjustment of the drive motor (16a; 16b) between the initial position and the final position.

6. The tensioner (17) according to claim 5, characterized in that the slip-on bolt (14) extends through a recess (9a; 9b; 33) on the bottom roller carrier (1).

7. The tensioner (17) according to claim 6, characterized in that the recess (33) forms an edge side of the bottom roller carrier (1).

8. The tensioner (17) according to claim 1,
characterized in that the bottom roller carrier (1) has an upper side (1b) and a lower side (1c), wherein the bottom rollers (2a; 2b) are arranged mounted on the upper side (1b) of the bottom roller carrier (1), and a carrying element (la) is provided which projects vertically from the lower side (1c) and on which the at least one drive motor (16a; 16b) is mounted, wherein the drive belt (3a; 3b) extends from the drive motor (16a; 16b) to the associated bottom roller (2a; 2b) traversing the bottom (1c) and upper sides (1b) of the bottom roller carrier (1).

9. The tensioner (17) according to claim 8, characterized in that the bottom roller carrier (1) has at least one passage (le) through which the drive belt (3a; 3b) extends.

10. The tensioner (17) according to claim 1, characterized in that the bottom roller carrier (1) has at least one receptacle (10a; 10b; 22a; 22b) for receiving at least one locking screw (15) extending through the bottom roller carrier (1) and fixing the at least one drive motor (16a; 16b) in the set position.

11. A belt tensioner jaw (24) for adjusting the drive belt tension of a tensioner (17), particularly for a tensioner (17) according to any of claims 1 to 10, comprising two jaw halves (26a, 26b) pivotally connected to one another via a hinge bolt (25), one ends of which are designed as handles (27) and the other ends of which each have a functional element (28a, 28b) jointly forming a pair of functional elements (31a, 31b), which are arranged in the same movement plane and can be moved towards one another by actuating the jaw halves (26a, 26b),
characterized by
a pretensioning element (30) which pretensions the functional elements (28a, 28b), which are designed as slip-on bushings for the receptacle of a holding bolt (13) and a slip-on bolt (14) and extend perpendicularly to the plane of movement, towards one another with a defined pretensioning force.

12. The belt tensioner jaw (24) according to claim 11, characterized in that the functional elements (28a, 28b) of a pair of functional elements (31a, 31b) are arranged at the same distance from the hinge bolt (25).

13. The belt tensioner jaw (24) according to claim 11, characterized by at least two pairs of functional elements (31a, 31b) arranged at different distances from the hinge bolt (25) at the other ends of the jaw halves (26a, 26b).

14. The belt tensioner jaw (24) according to any of claim 11, characterized in that the pretensioning element is designed as a tension spring (30) arranged in the area between the pair of functional elements (31a, 31b) and the hinge bolt (25) on the jaw halves (26a, 26b).

15. A system for tensioning a drive belt (3a; 3b) of a tensioner (17), having a tensioner (17) according to any of claim 1 and a belt tensioner jaw (24)
characterized in that slip-on bolts (28a, 28b) arranged on the belt tensioner jaw (24) are adapted to slip-on bolts (14) and holding bolts (13) on the tensioner (17).

16. The system according to claim 15, characterized in that a pretensioning element (30) is designed on the belt tensioner jaw (24) in such a manner that the belt tensioner jaw (24) arranged on the holding bolt (13) and the slip-on bolt (14) pretensions the drive belt (3a, 3b) with a predetermined belt tension.

17. The system according to claim 15, characterized in that the tensioner (17) has two pairs of rollers each with a drive motor (16a, 16b) connected to a bottom roller (2a, 2b) and the belt tensioner jaw (24) has two pairs of functional elements (31a, 31b) for setting different belt tensions.
